(19) United States
(12) Patent Application Publication
(10) Pub. No.: US 2007/0238354 A1
(43) Pub. Date: Oct. 11, 2007

(54) Rotary Shaft Structure

(76) Inventor: Lin-Chien Yu, Kuei San Hsiang (TW)

Correspondence Address: LAW OFFICES OF LAI & ASSOCIATES, P.C., 5800 RANCHESTER STE 200, HOUSTON, TX, 77036, US

(21) Appl. No.: 11/697,181

(22) Filed: Apr. 5, 2007

(30) Foreign Application Priority Data
Apr. 6, 2006 (TW) 095112263

(51) Int. Cl. H01R 13/648

(52) U.S. Cl. 439/607

(57) ABSTRACT

A rotary shaft structure includes a fastening rack, a fastening shell, a spherical lid, a wedge, an elastic body and a holder. A top of the fastening rack is connected to a fastening base. A bottom of the fastening rack has a connection body. The fastening shell is used to fasten the connection body. The spherical lid is used to accommodate the fastening shell, the wedge and the elastic body. The wedge is for tightening the fastening shell. The elastic body provides pressures while tightening the fastening shell. An end of the holder is connected to the spherical lid, and tightens the elastic body.

### FIELD OF THE INVENTION

The present invention generally relates to a rotary shaft structure, and more specifically relates to the rotary shaft structure that adjusts the rotating axis angle by using a fastening shell of a fastening rack.

### BACKGROUND OF THE INVENTION

When technology is developed gradually, various information products are successively presented to the public, thereby improving our daily life substantially. In the information products, portable electronic products further improve our mobile life.

When a user uses a portable electronic apparatus in a vehicle or other transportations, a fastening base is often used to fasten the portable electronic apparatus. However, the spindle structure of the fastening base in the prior art is immovable. For instance, the spindle angle of the fastening base taught in Taiwan Patent No. 087216985 and No. 085211592 may not be adjusted in the light of user's demands resulting in inconvenience.

To overcome the foregoing shortcoming, the inventor of the present invention based on years of experience in the related field from conducting extensive research and experiments, invents a rotary shaft structure as a method or a basis for achieving the aforementioned object.

### SUMMARY OF THE INVENTION

Briefly, it is an objective of the present invention to provide a rotary shaft structure. More specifically, the rotating axis angle of the rotary shaft structure can be adjusted by using a fastening shell of a fastening rack.

To achieve of the foregoing objective, the rotary shaft structure of the invention comprises a fastening rack, a fastening shell, a spherical lid, a wedge, an elastic body and a holder. The fastening rack is connected to the fastening base from a top of the fastening rack. A bottom of the fastening rack has a connection body. The fastening shell is used to fasten the connection body. The spherical lid is used to accommodate the fastening shell, the wedge and the elastic body. The wedge is used to tighten the fastening shell. The elastic body provides pressures while tightening the fastening shell. The holder is used to tighten the elastic body and connected to the spherical lid from an end of the holder.

Therefore, the rotary shaft structure allows the fastening shell, the spherical lid and the wedge to generate a damped slide through the pressures provided by the elastic body, thereby adjusting the rotating axis angle.

To make it easier for our examiner to understand the object of the invention, its innovative features and performance, a detailed description and technical characteristics of the present invention are described together with the drawings as follows.

### BRIEF DESCRIPTION OF THE DRAWINGS

FIG. 1 is an exploded assembly drawing of a rotary shaft structure of the present invention;

FIG. 2 is a top view of a rotary shaft structure of the present invention;

FIG. 3 is a cross-sectional drawing of a rotary shaft structure of the present invention;

FIG. 4 is another top view of a rotary shaft structure of the present invention;

FIG. 5 is another cross-sectional drawing of a rotary shaft structure of the present invention; and

FIG. 6 is a schematic diagram of a rotary shaft structure, an electronic apparatus and a fixing base of the present invention.

### DETAILED DESCRIPTION OF THE PREFERRED EMBODIMENTS

Referring to the related figures for the rotary shaft structure according to a preferred embodiment of the present invention, wherein the same elements are described by the same reference numerals.

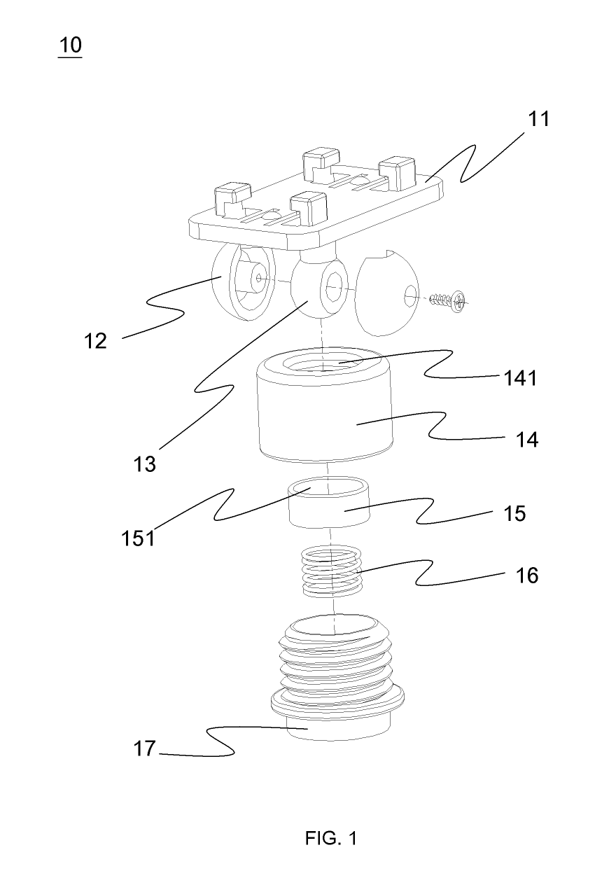

Referring to FIG. 1 for the exploded assembly drawing of a rotary shaft structure of the invention, the rotary shaft structure is applied to a fastening base capable of accommodating a portable electronic apparatus. The rotary shaft structure 10 comprises a fastening rack 11, a fastening shell 12, a spherical lid 14, a wedge 15, an elastic body 16 and a holder 17. The fastening rack 11 is connected to the fastening base from a top of the fastening rack 11 and a bottom of the fastening rack 11 has a connection body 13. The fastening shell 12 is used to fasten the connection body 13. The spherical lid 14 is for accommodating the fastening shell 12, the wedge 15 and the elastic body 16. The wedge 15 is used to tighten the fastening shell 12. The elastic body 16 provides pressures while tightening the fastening shell 12. The holder 17 is used to tighten the elastic body 16 and connected to the spherical lid 14 from an end of the holder 17.

The elastic body 16 is preferably a spring. The fastening shell 12 and the wedge 15 are disposed into the spherical lid 14. An interior hole of a top of the spherical lid 14 is against an upper portion of the fastening shell 12. The wedge 15 is disposed to a lower portion of the fastening shell 12, and tightens the fastening shell 12 from the lower portion. The interior hole of the top of the spherical lid 14 is incorporated with the fastening shell 12 from the upper portion to form a first arc surface 141. The wedge 15 is incorporated with the fastening shell 12 from the lower portion to form a second arc surface 151. The fastening shell 12 is composed of a first half shell and a second half shell. An inside of the fastening shell 12 is used to accommodate the connection body 13. The holder 17 further has an external thread for screwing with an internal thread of the spherical lid 14, thereby connecting the spherical lid 14.

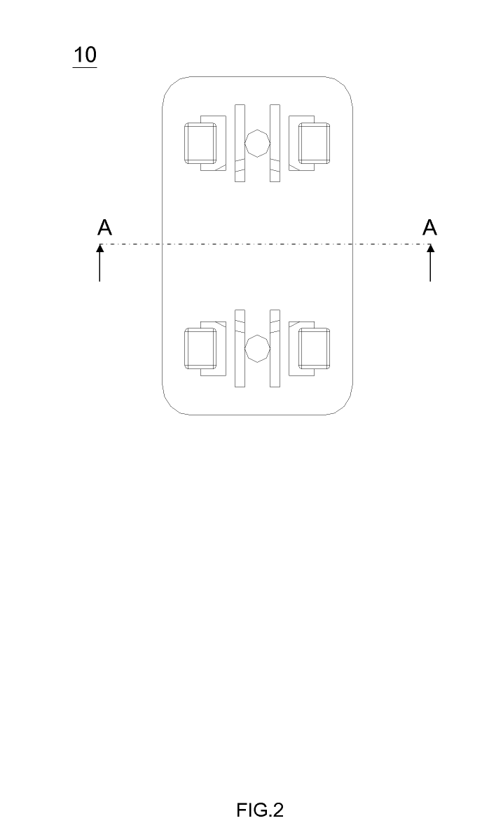

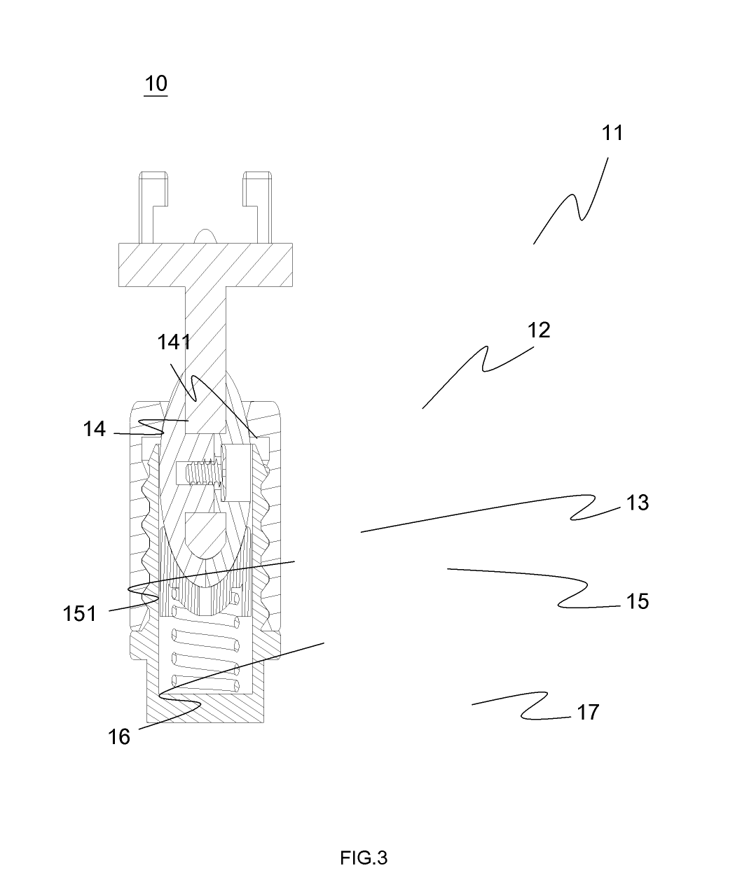

Referring to FIG. 2 and FIG. 3, FIG. 2 is a top view of a rotary shaft structure of the invention and FIG. 3 is a cross-sectional drawing of a rotary shaft structure of the invention. The line segment AA shown in FIG. 2 is taken as a section for the cross-section shown in FIG. 3 such that the inside of the rotary shaft structure 10 can be clearly seen. The connection body 13 of the fastening rack 11 passes through the spherical lid 14. The first half shell, the second half shell and the connection body 13 then are combined together by using a screw to become the fastening shell 12, and the wedge 15 disposed in the holder 17 then is utilized to dispose the fastening shell 12 onto the wedge 15. A bottom of the wedge 15 is supported by the elastic body 16. Lastly, the external thread of the holder 17 is screwed with the internal thread of the spherical lid 14 so as to assemble the rotary shaft structure 10 of the invention.

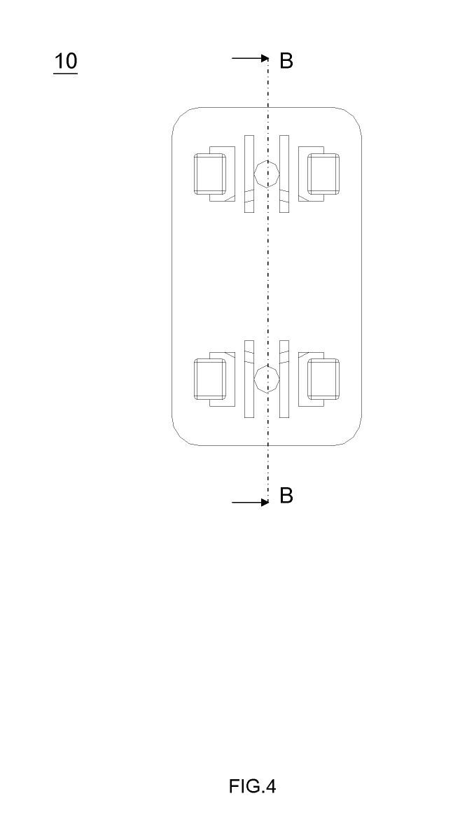

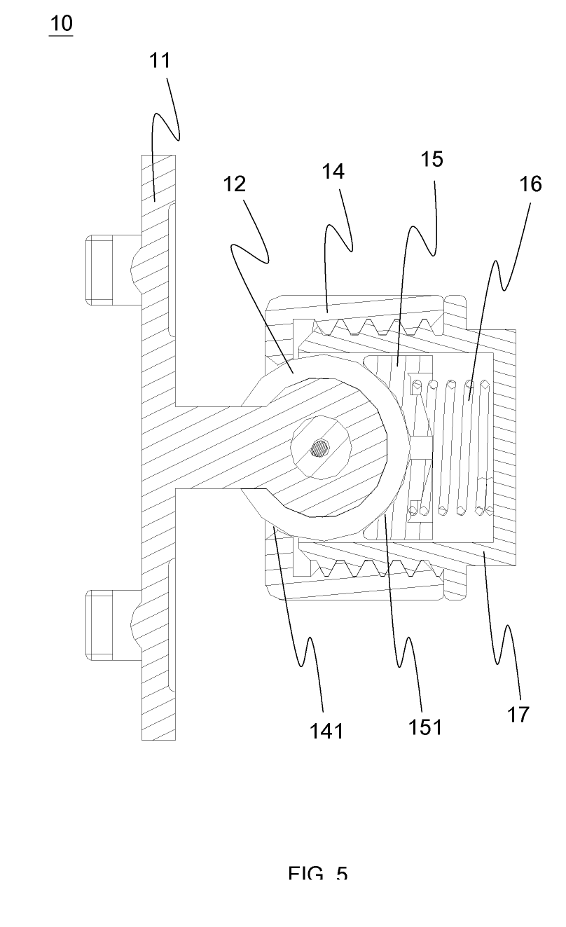

Referring to FIG. 4 and FIG. 5, FIG. 4 is another top view illustrating a rotary shaft structure of the invention and FIG. 5 is another cross-sectional drawing illustrating a rotary shaft structure of the invention. The line segment BB shown in FIG. 4 is taken as a section for the cross-section shown in FIG. 5 such that the inside of another angle of the rotary shaft structure 10 can be clearly seen. The fastening shell 12 and the wedge 15 are disposed into the spherical lid 14. The interior hole of the top of the spherical lid 14 is against the upper portion of the fastening lid 12. The wedge 15 is disposed under the fastening shell 12 and the fastening shell 12 then is tightened. The interior hole of the top of the spherical lid 14 is incorporated with the fastening shell 12 from the upper portion to form a first arc surface 141. The wedge 15 is incorporated with the fastening shell 12 from the lower portion to form a second arc surface 151. When the interior thread of the spherical lid 14 is screwed with the external thread of the holder 17, the spherical lid 14 and the wedge 15 tighten the fastening shell 12 simultaneously. Moreover, the elastic body 16 provides pressures while tightening the fastening shell 12 such that the first arc surface 141 and the second arc surface 151 generate a damped slide, thereby conveniently adjusting the angle of the fastening rack 11.

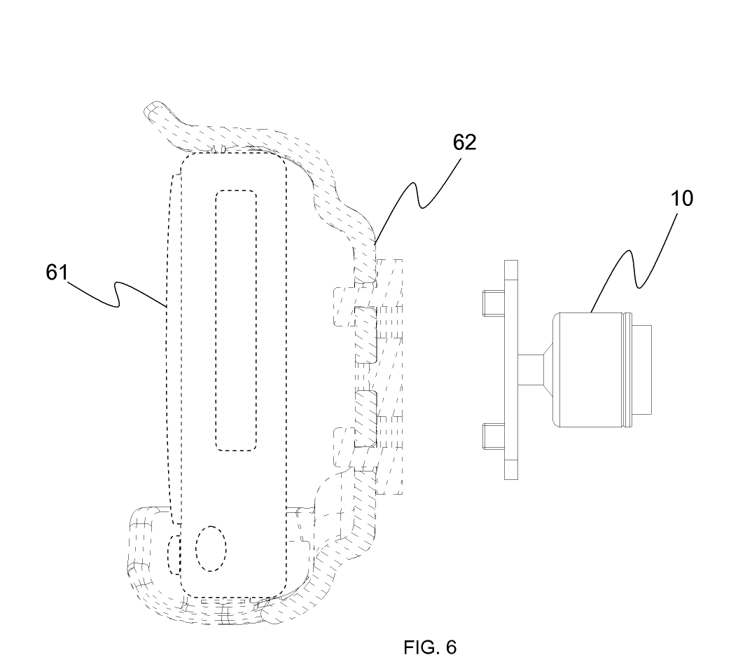

Referring to FIG. 6, a schematic diagram illustrates a rotation shaft structure, an electronic apparatus and a fastening base of the invention. The fastening base 62 is used to fasten the portable electronic apparatus 61. The rotation shaft structure 10 of the invention is combined with the fastening base 62 through the fastening rack. The user can adjust the position of the portable electronic apparatus through the rotation shaft structure 10 while operating the portable electronic apparatus 61.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A rotary shaft structure for a fastening base capable of accommodating a portable electronic apparatus, comprising:
a fastening rack connected to the fastening base from a top of the fastening rack, a bottom of the fastening rack having a connection body;
a fastening shell for fastening the connection body;
a wedge for tightening the fastening shell;
an elastic body for providing pressures while tightening the fastening shell;
a spherical lid for accommodating the fastening shell, the wedge and the elastic body; and
a holder for tightening the elastic body, and for connecting the spherical lid from an end of the holder.

2. The rotary shaft structure of claim 1, wherein the fastening shell and the wedge are disposed into the spherical lid, and an interior hole of a top of the spherical lid is against an upper portion of the fastening shell, and the wedge is disposed to a lower portion of the fastening shell and tightens the fastening shell from the lower portion, and the interior hole of the top of the spherical lid is incorporated with the fastening shell from the upper portion to form a first arc surface, and the wedge is incorporated with the fastening shell from the lower portion to form a second arc surface.

3. The rotary shaft structure of claim 3, wherein the rotary shaft structure is the holder connected the spherical lid to allow the spherical lid and the wedge to tighten the fastening shell, and the elastic body provides pressures while tightening the fastening shell such that the first arc surface and the second arc surface generate a damped slide, thereby adjusting the angle of the fastening rack.

4. The rotary shaft structure of claim 1, wherein the elastic body is a spring.

5. The rotary shaft structure of claim 1, wherein the fastening shell is assembled by a first half shell and a second half shell, and the inside of the fastening shell is used to accommodate the connection body.

6. The rotary shaft structure of claim 1, wherein the holder further has an external thread for screwing with an internal thread of the spherical lid, thereby connecting the spherical lid.
